(19) United States
(12) Patent Application Publication
(10) Pub. No.: US 2008/0126777 A1
(43) Pub. Date: May 29, 2008

(54) EXTERNAL BASIC INPUT/OUTPUT SYSTEM DEVICE

(75) Inventors: An-Sheng Chang, Taipei Hsien (TW); Jinn-Rong Juang, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: GIGA-BYTE TECHNOLOGY CO.,LTD., Taipei Hsien (TW)

(21) Appl. No.: 11/467,570

(22) Filed: Aug. 28, 2006

(51) Int. Cl. G06F 9/00

(52) U.S. Cl. 713/2; 714/2

(57) ABSTRACT

An external basic input/output system (BIOS) device for a computer is disclosed. The device includes an external memory module and a motherboard pin interface. The backup BIOS is stored in the external memory module. When the main BIOS is damaged, the external backup BIOS can replace the main BIOS to execute power-on procedures of the computer. The backup BIOS can also recover the correct data to the damaged main BIOS. The external backup device needs to be installed only when a severe error occurs in the main BIOS. Therefore, the present invention reduces the cost of motherboards and at the same time offers the advantages of a conventional dual BIOS system.

### BACKGROUND OF THE INVENTION

1. Field of the Invention

The present invention relates to an external basic input/output system (BIOS) backup device, and more particularly, to a basic input/output system (BIOS) with recovering and backup functions.

2. Description of Related Art

Basic input/output system (BIOS) is the firmware stored in the read-only-memory (ROM) of a motherboard. The main function of BIOS is to perform a power-on inspection on computer hardware and various peripheral devices, and then initialize the hardware to ensure the system can operate normally. After turning on a computer system, a central processing unit (CPU) inside the computer automatically retrieve programs from the BIOS to perform a power-on self test (POST). Then, an operating system is downloaded. After that, the control of the computer system is transferred to the operating system, thereby completing the start-up procedure.

Before a motherboard is shipped out of a factory, the system manufacturers will normally write the BIOS data into the read-only-memory of the motherboard. However, for some reasons such as failure to update an older version of BIOS data into a newer version, an attack by a computer virus or some other problems, the data within the BIOS may be so damaged that the power-on procedures of the computer cannot be completed. As a result, the computer cannot be used.

To combat the problem of not being able to start up a computer when the data within the one and only BIOS is damaged, a dual BIOS technique has been developed. A computer system deploying this technique includes a memory for storing the main BIOS on a motherboard and another memory for storing the external backup BIOS. When the computer system fails to start up because the main BIOS has been attacked by computer virus or the update of BIOS data has been a failure, the external backup BIOS device can replace the main BIOS device on the motherboard to complete the computer power-on procedures. After starting up the computer system, the backup BIOS can even be used to recover the correct data of the damaged main BIOS. However, the backup BIOS on the motherboard in fact is a backup component that is seldom used. In fact, a user purchasing this type of motherboard is actually buying two memory units that store the same BIOS programs simultaneously. Thus, not only is the cost of the motherboard increased, but also produce a functional waste. In addition, the memory for storing the backup BIOS is conventionally embedded inside the motherboard. To repair the backup BIOS, components have to be disassembled and de-soldered manually. Hence, the difficulties of repairing the backup BIOS and the risk a repair failure are increased.

### SUMMARY OF THE INVENTION

Accordingly, at least one objective of the present invention is to provide an external basic input/output system (BIOS) device such that, by changing from an embedded backup BIOS device on a motherboard to an external device, the external backup device is installed only when required. Thus, the cost of the motherboard is reduced and the procedure for repairing the motherboard is simplified.

To achieve these and other advantages and in accordance with the purpose of the invention, as embodied and broadly described herein, the invention provides an external basic input/output system (BIOS) device. The device includes an external memory module for storing a backup BIOS. When the main BIOS of a computer system is damaged, the backup BIOS can be used to start up the computer system and recover the correct data to the main BIOS. Furthermore, the present invention also includes a low pin count (LPC) bus interface embedded in the motherboard to provide a plurality of pins. The computer system can read data from or write data to the backup BIOS through the pins of the low pin count bus interface.

According to the external BIOS device in one preferred embodiment of the present invention, the external memory module includes a memory for storing the backup BIOS and a connector for connecting the memory to the motherboard pin interface.

According to the external BIOS device in one preferred embodiment of the present invention, the memory is a flash memory.

According to the external BIOS device in one preferred embodiment of the present invention, the connector is a standard 25-pin parallel port D-type connector.

According to the external BIOS device in one preferred embodiment of the present invention, the signal pins of the connector is defined according to the pins of a flash memory.

According to the external BIOS device in one preferred embodiment of the present invention, the connector interface includes a low pin count (LPC) bus.

According to the external BIOS device in one preferred embodiment of the present invention, the device further includes a connection module for connecting the external memory module and the motherboard pin interface.

According to the external BIOS device in one preferred embodiment of the present invention, the connection module further includes an external adapter for connecting with the external memory module and a connection cable for connecting the motherboard pin interface and the external adapter to serve as a transmission medium.

According to the external BIOS device in one preferred embodiment of the present invention, the external adapter is a standard 25-pin parallel port D-type connector.

According to the external BIOS device in one preferred embodiment of the present invention, the external adapter includes a low pin count (LPC) bus.

According to the external BIOS device in one preferred embodiment of the present invention, the connection module further includes an attaching member for fixing the external adapter to the case of the computer system.

Accordingly, the present invention deploys an external backup BIOS module. When the main BIOS is damaged that the system cannot start on, the external backup BIOS module can be connected so that the backup BIOS capable of performing normal power-on procedures instead of the faulty main BIOS on the motherboard is used to execute the normal power-on procedures. Furthermore, the backup BIOS can recover the data in the faulty main BIOS to that of the backup BIOS. Therefore, the cost of the motherboard purchased by a customer is reduced and the procedures for repairing the BIOS are simplified. In the meantime, the advantages of a conventional dual BIOS system are offered.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an external BIOS device according to one preferred embodiment of the present invention.

FIG. 2 is a flow diagram showing the steps for using the external BIOS device according to one preferred embodiment of the present invention.

FIG. 3 is a schematic diagram showing a BIOS setup menu interface according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

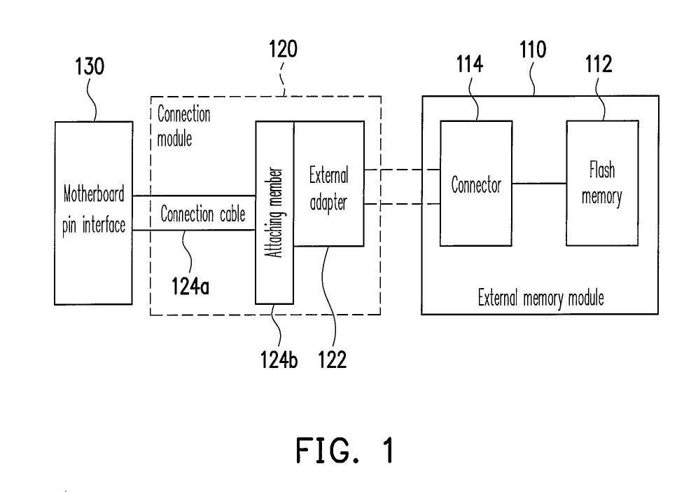

FIG. 1 is a block diagram of an external BIOS device according to one preferred embodiment of the present invention. As shown in FIG. 1, the external basic input/output system (BIOS) device in the present embodiment carries a backup BIOS suitable for replacing the main BIOS of a computer system to start up the computer system when the main BIOS data is damaged. The present embodiment includes an external memory module 110 for storing a backup BIOS and a motherboard pin interface 130 embedded within the motherboard of the computer system to provide a plurality of pins for reading data from the external memory module 110. Furthermore, the present embodiment also includes a connection module 120 for connecting the external memory module 110 to the motherboard pin interface 130.

Again, as shown in FIG. 1, the external memory module 110 further includes a memory 112 and a connector 114. The memory 112 is a flash memory (flash ROM) for storing the aforementioned backup BIOS. The backup BIOS memory 112 has the same size and type as the main BIOS memory does. If necessary, the memory 112 may be replaced with another memory with different size and/or type. The connector 114 is used for connecting the memory 112 and the connection module 120.

The foregoing connector 114 is a standard 25-pin parallel port D-type connector and the corresponding signals in the pins of the connector 114 are defined according to the signals corresponding to the pins of the memory 112. Furthermore, the connector 114 is compatible with low pin count (LPC) bus interface. The LPC bus is the interface of the motherboard commonly used by motherboard manufacturers. Since the LPC bus has already been included inside the motherboard, there is no need to provide additional component to support this interface. From another perspective, the LPC bus has a working frequency of 33 MHz, which is higher than that of a parallel port interface. Therefore, the capacity to update and recover the main BIOS is faster.

The connection module 120 includes an external adapter 122 for connecting with the external memory module 110. More specifically, the external adapter 122 is a standard 25-pin parallel port D-type connector with an LPC bus interface capable of connecting with the connector 114 of the external memory module 110. Furthermore, the connection module 120 also includes a connection cable 124a. One end of the connection cable 124a has an attaching member 124b for fixing the external adapter 122 to the case of the computer system. Another end of the connection cable 124a is connected to the motherboard pin interface 130. The end of the connection cable 124a with the attaching member 124b is connected to the external adapter 122. The attaching member 124b may be a metal plate fixed at the back of the case of the computer system, or some other hardware which fixes the external adapter 122 to the case of the computer system. When the external memory module 110 is connected to the motherboard pin interface 130 through the connection module 120, the computer system can detect signals from the external memory module 110 through the motherboard pin interface 130 and read from the backup BIOS.

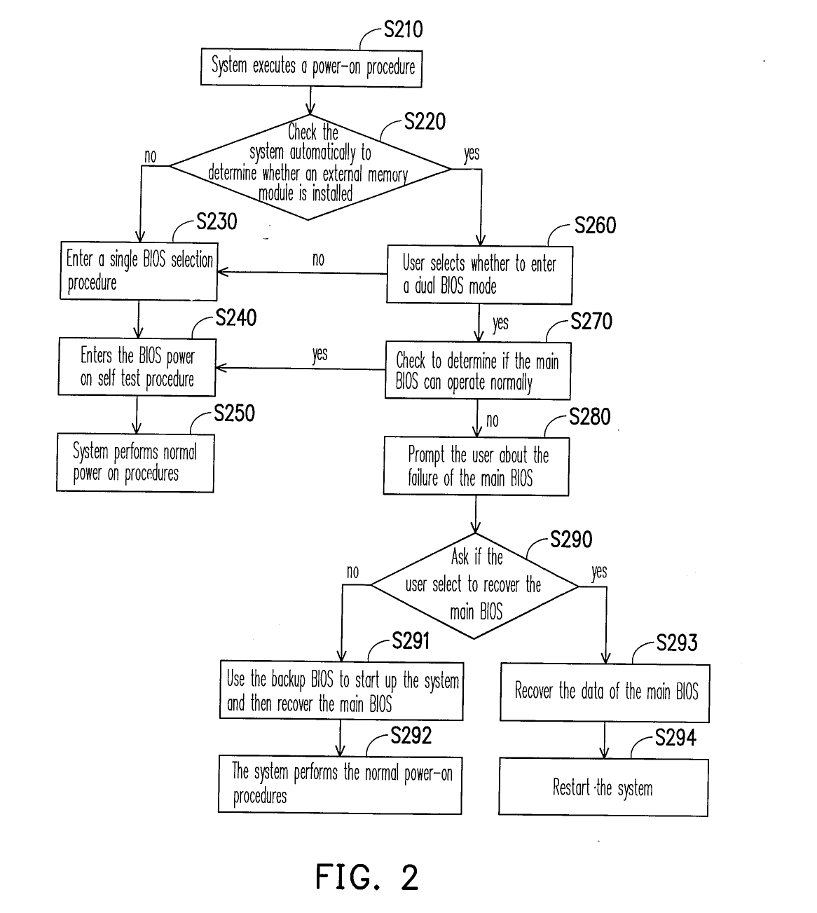

In the following, the method of using the external BIOS device in the present embodiment is described. FIG. 2 is a flow diagram showing the steps for using the external BIOS device according to one preferred embodiment of the present invention. As shown in FIGS. 1 and 2, the system executes a power-on operation (step S210). Then, the system is automatically checked to determine if an external memory module is installed (step S220). If no external memory module is installed, then a single BIOS selection procedure is executed (step S230). After that, a BIOS power-on self test (POST) is executed (step S240). Next, the system executes a normal power-on procedure (step S250). If an external memory module has been detected in step S220, the user has the option of selecting whether to enter a dual BIOS mode (step S260). When the user chooses to enter a dual BIOS mode, the main BIOS is inspected to determine if it operates normally (step S270); otherwise, step S230 is executed.

In step S270, if the main BIOS operates normally, step S240 is executed using the main BIOS to perform the normal power-on procedures. On the other hand, if the main BIOS cannot operate normally, then the failure of the main BIOS is prompted (step S280). The system can inform the user about the failure of the main BIOS through a message on a screen or sounding an alarm. Next, the user may select whether to recover the main BIOS (step S290). If the user decides not to recover the main BIOS for the time being, the backup BIOS is used to start up the system before recovering the main BIOS (step S291). Then, the system executes the normal power on procedures (step S292). Conversely, the data within the main BIOS are immediately recovered (step S293) by the external BIOS and the system is activated again (step S294) after the recovery of the data is finished.

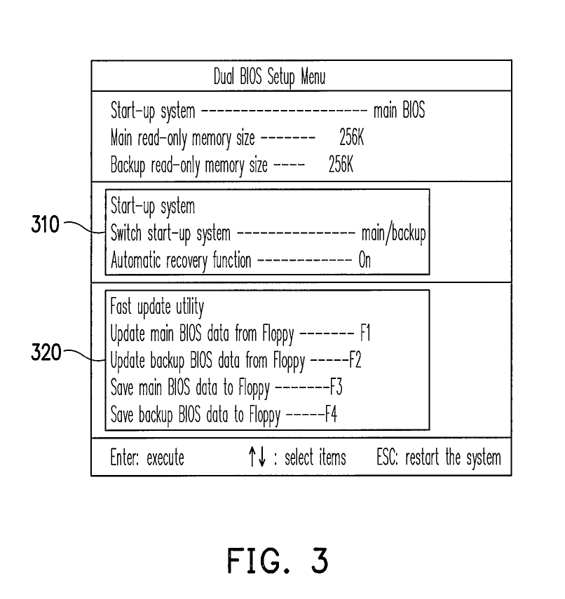

FIG. 3 is a schematic diagram showing a BIOS setup menu interface according to one preferred embodiment of the present invention. As shown in FIG. 3, the menu uses texts to remind a user about the current start-up system and the memory capacity of the main or backup BIOS.

In the start-up system interface 310, the user can switch between using the main or the backup BIOS as the default start-up system and set the automatic recovering function. When the computer system discovers some of the data in the main BIOS are in error so that the computer cannot start up, the backup BIOS may be used to execute the power on function instead of the damaged main BIOS and recover the data within the damaged main BIOS.

In the fast update utility interface 320, the user can select to read the data from a floppy disc storage medium and update the main or the backup BIOS (for example, the F1 and the F2 selections in the fast update utility interface 320).

In addition, the user may also select to save the correct data in the main BIOS or the backup BIOS to a floppy disc storage medium (for example, the F3 and F4 selections in the backup system interface 320).

In summary, the present invention stores the backup BIOS in an external memory module and the external memory module can connect with the motherboard. When the main BIOS is defective, the backup BIOS is read to perform the power on procedures and recover the defective main BIOS. Therefore, the computer system can start up normally. The consumer has the option to purchase this external memory module or not so as to reduce the cost of purchasing the motherboard. Moreover, compared with a conventional dual BIOS that needs to check both the main BIOS and the backup BIOS every time the system is turned on, the computer only has to check the main BIOS when the backup BIOS memory module of the present invention is not installed. Thus, the computer will check the backup BIOS only when the external backup BIOS memory module is installed. In other words, using the present invention, the computer system can enjoy the advantage of a faster starting up of single BIOS technique and yet has the advantage of the recovering function of dual BIOS technique. Furthermore, the backup BIOS in the present invention is an externally connected device so that the difficulties of dismantling the BIOS memory and the high risk of failure in a conventional repair operation are avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An external basic input/output system (BIOS) device, comprising:
an external memory module for storing a backup BIOS such that when the data within a main BIOS of a computer system are damaged, the backup BIOS can start up the computer system and recover the main BIOS; and
a motherboard pin interface embedded on the motherboard of the computer system for providing a plurality of pins such that the computer system can read data from the backup BIOS through the pins.

2. The external BIOS device of claim 1, wherein the external memory module comprises:
a memory for storing the backup BIOS; and
a connector for connecting the memory to the motherboard pin interface.

3. The external BIOS device of claim 2, wherein the memory is a flash memory.

4. The external BIOS device of claim 2, wherein the connector is a standard 25-pin parallel port D-type connector.

5. The external BIOS device of claim 2, wherein the signal pins of the connector are defined according to the definition of the pins of the memory.

6. The external BIOS device of claim 2, wherein the connector is compatible with low pin count (LPC) bus interface.

7. The external BIOS device of claim 1, further comprising a connection module for connecting the external memory module and the motherboard pin interface.

8. The external BIOS device of claim 7, wherein the connection module comprises:
an external adapter for connecting with the external memory module; and
a connection cable for connecting the motherboard pin interface and the external adapter.

9. The external BIOS device of claim 8, wherein the external adapter is a standard 25-pin parallel port D-type connector.

10. The external BIOS device of claim 8, wherein the external adapter is compatible with low pin count (LPC) bus interface.

11. The external BIOS device of claim 8, wherein the connection module further comprises an attaching member for fixing the external adapter to the case of the computer system.
